(19) United States
(12) Patent Application Publication
(10) Pub. No.: US 2014/0337762 A1
(43) Pub. Date: Nov. 13, 2014

(54) SYSTEM AND METHODS FOR IMPROVED SOCIAL NETWORKING

(71) Applicants: Ryan Salerno, Cortlandt Manor, NY (US); Michael Klein, New Rochelle, NY (US)

(72) Inventors: Ryan Salerno, Cortlandt Manor, NY (US); Michael Klein, New Rochelle, NY (US)

(21) Appl. No.: 14/205,475

(22) Filed: Mar. 12, 2014

Related U.S. Application Data
(60) Provisional application No. 61/822,607, filed on May 13, 2013.

(51) Int. Cl. H04L 29/06; G06F 3/0488

(52) U.S. Cl. CPC H04L 65/403; G06F 3/0488
USPC 715/753; 715/840

(57) ABSTRACT

A system and methods for implementing a social network includes customizable operations including custom expression buttons implemented by a user. Comments posting operation allows a user to move around within the comments area for and a user may move within a specific user's posts and move around within that user's posts for implementing a social network.

### CROSS-REFERENCE TO RELATED APPLICATION DATA

The present application claims priority to U.S. Provisional Patent Application No. 61/822,607, filed May 13, 2013 and U.S. Provisional Patent Application No. 61/779,611, filed Mar. 13, 2013, the entirety of which are incorporated herein by reference.

### FIELD

The present invention relates to features in a computer implemented social networking environment.

### BACKGROUND

Social networks are known, such as Facebook® and LinkedIn®. These networks are known for their various features and ability to connect people in a computer network. These networks provide various aspects in their user interfaces that limit the experience of the users engaging via the network.

### SUMMARY OF THE INVENTION

The present disclosure provides new systems and methods for interfacing via a computer-based social networking platform. Features of the disclosure are implemented in the social networking environment via a user interface implemented on the user's interface device, such as a smartphone, tablet or other user interface device implementation.

### BRIEF DESCRIPTION OF THE DRAWINGS

For the purpose of facilitating an understanding of the invention, there is illustrated in the accompanying drawings an illustrative embodiment and alternative embodiments thereof, from an inspection of which, when considered in connection with the following description, the invention, its construction and operation, and many of its advantages, should be readily understood and appreciated.

FIG. 1 is an illustrative embodiment of a system for implementing a social network according to the disclosure;

FIG. 2 is a flow diagram illustrating flow of GET and POST operations for implementing a social network according to the disclosure;

FIG. 3A is a diagram illustrating processing a post operation for implementing a social network according to the disclosure;

FIG. 3B is a flow diagram illustrating processing a post operation for implementing a social network according to the disclosure;

FIG. 4A is a diagram illustrating implementation of a custom expression button operation for implementing a social network according to the disclosure;

FIG. 4B is a flow diagram illustrating processing of a custom expression button operation for implementing a social network according to the disclosure;

FIG. 5 is a flow diagram illustrating flow of comments posting operation for implementing a social network according to the disclosure;

FIG. 6A is a flow diagram illustrating a process for a user to delete and/or move the placement of their comments for a certain post within the comments area for implementing a social network according to the disclosure;

FIGS. 6B and 6C are diagrams illustrating a user comment being moved around within the comments area for implementing a social network according to the disclosure;

FIGS. 7A and 7B are diagrams illustrating a user move within a specific user's posts and move around within that user's posts for implementing a social network according to the disclosure;

FIG. 7C is a flow diagram illustrating a process for a user to move within a specific user's posts and move around within that user's posts for implementing a social network according to the disclosure;

FIG. 8 is an illustrative embodiment of a computing device for implementing a social network according to the disclosure; and

FIG. 9 is a diagram illustrating interaction of computing devices.

### DETAILED DESCRIPTION

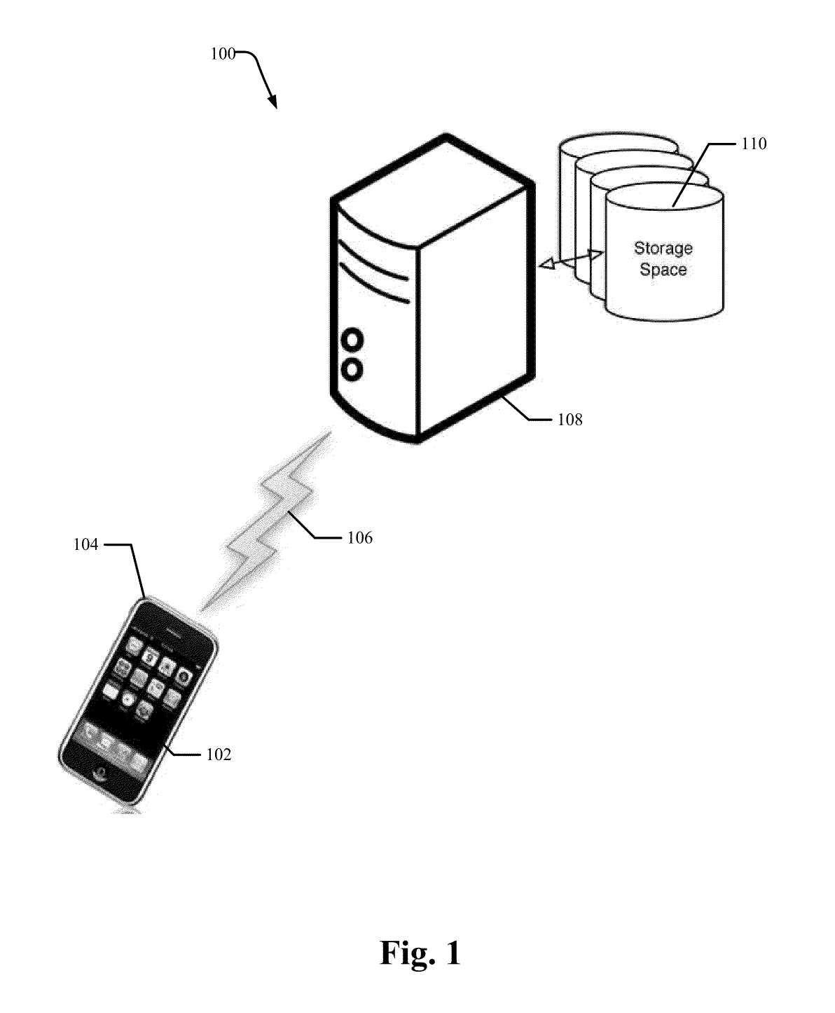

Detailed embodiments of systems, methods, and apparatuses are disclosed and illustrated herein in FIGS. 1 through 9, however, it is to be understood that those embodiments are merely exemplary of the systems, methods, and apparatuses which may be embodied in various forms. Therefore, specific functional details disclosed and illustrated herein are not to be interpreted as limiting, but merely as a basis for the claims and as a representative basis for teaching one skilled in the art to employ various versions, implementations, and/or applications of the disclosed systems, methods, and apparatuses.

Generally, the systems, methods, and apparatuses disclosed herein include and may be implemented within a computer, computer system, and/or network of computer systems having one or more databases and other storage apparatuses, servers, and additional components, such as processors or microprocessors, modems, terminals and displays, non-transitory computer-readable media, algorithms, software, modules, platforms, and other computer-related components. The computer systems are especially configured and adapted to perform the functions and processes of the systems, methods, and apparatuses as disclosed herein. The functions and processes of the systems, methods, and apparatuses as disclosed herein may be embodied in a stand-alone platform or application, a web-based application or platform such as a Software-as-a-Service (SaaS), or other type of application or platform, and may include one or more graphical user interfaces (GUIs) that can be accessed over a network such as the World Wide Web (W3) and/or the Internet and other types of networks including communications networks, Local area networks (LANs), Metropolitan area networks (MANs), Campus area networks (CANs), Wide area networks (WANs), wireless networks, and other networks of the type.

Communications between various components in the systems, methods, and apparatuses disclosed herein may be bidirectional electronic communication through a wired or wireless network. For example, one component may be networked directly, indirectly, through a third party intermediary, wirelessly, or otherwise with other components to enable communication between the components.

Referring to FIG. 1, a system 100 of how to implement and use a mobile social networking platform is described. The service works, such as in the form of a user application or “app,” by creating a local interface 102 on a user's device 104, which interacts over a wireless connection 106 with a main server 108 that stores data in a storage space 110. Through the interface 102, users may browse or add content that exists on the server 108. This content can range from user posts such as text, images, video and locations, to user settings and network relations.

A pivotal part of the application lies on the server 108, as no information exists without it. The server 108 runs on a basic LAMP service (Linux, Apache, MySQL, PHP). The server 108 may have a Linux operating system, which may use Apache and PHP to send and receive data from the client as well as a MySQL database, which stores all of the data. Once Apache and PHP is installed and started, PHP scripts are saved on the server 108 to act as the middleman between the client and the database.

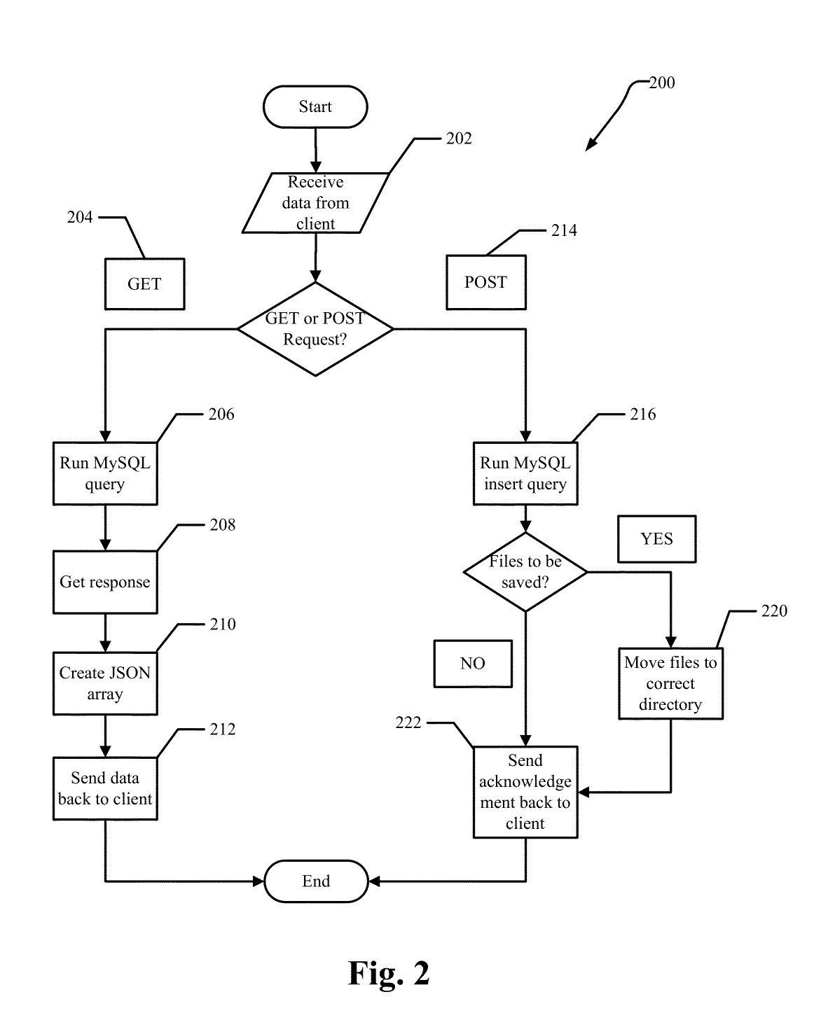

As referred to in FIG. 2, there are two different ways to interact with the server: a user can upload new data or download existing data. If a user is trying to access existing data, depending on what the user is trying to access, the client will perform a receiving step 202 by uploading the user's credentials, along with any other necessary data, using an HTTP “GET” request 204. At this point, the PHP script for that request will collect the request and subsequently perform another step 206 by running a query on the MySQL database. Once the query is complete, a further step 208 occurs where the server receives the response indicating the query is complete. Then, a creation step 210 occurs where the results are wrapped in a JSON array, which will then trigger a sending step 212 that includes sending data back to the client for viewing.

If a user is attempting to upload new data, the data will be uploaded to the server using an HTTP “POST” request 214. Once again, a receiving step 202 occurs where the subsequent PHP script for that request will collect the data from the client and insert the data into the MySQL database. Once the receiving step 202 is complete, a running step 216 is performed where the data collected from the client is run through a MySQL insert query. Upon completion of the running step 216, it is determined if files are to be saved. If files are to be saved, a moving step 220 is performed where the files are moved to the correct directory. If files are not to be saved, or if files are to be saved and the moving step 220 has been performed, a sending step 222 transpires where acknowledgement is sent back to the client.

Once the server is set up and ready to interact with the client, the building of the actual application can begin. On a higher level, the basis of the application is that a user can use a local interface displayed on the device to interact with a server, which holds all of the data. Once again, a user can upload or download data from the server. If a user is attempting to upload new data, the client will collect any data that is necessary for that action, and then send it to the server. This data can include the user's credentials, the post content, or message from a user and even custom expressions described hereinafter. If a user is attempting to download data, again, the client will collect any data that is necessary for that action and send it to the server and wait for a response.

When a user decides to create a new post and selects the corresponding post type (text, images, video or location) from the header navigation bar, a new window will appear where the user can input certain information. This information includes any text they wish to link to the post, whether to make the post private or not, whether to share the post on Facebook and/or Twitter, who, if anyone, they would like to tag in the post, and finally, two custom expressions for the post which will later appear as buttons in the feed. When creating the post, the user has the ability to insert into two text fields/inputs a set number of characters for the two expressions to create the custom expression buttons. If nothing is inputted, default values for the two expressions will be used instead. Furthermore, a user has the ability to choose whether or not they want all users to be able to see their individual post. By selecting “private,” a user can share their content with only the users that they have tagged. Further, by making a post “private”, the post may be protected from unauthorized viewing by a variety of methods and means such as, for example, by using a passcode. This post will later appear in the feed just as any other post but marked in a certain way to note its privacy. One final feature is the ability to create custom locations. Using the Google Maps Places API, for example, when a user chooses to make a location based post, their location is automatically detected using the GPS coordinates provided by their device. These coordinates are then used with the API to find the nearest place of interest that user. When the user selects the location button within that posting page, they have the ability to either use the provided location from the Places API, or through the use of a textfield, have the ability to type in their own custom location. When the user is done creating the post and hits the “done” button, the data for that post along with the current user's credentials are wrapped into a string and sent to the server using an HTTP “POST” request.

Additionally, a user may decide to view posts submitted by other users. While viewing these posts, the user may filter the posts according to the content contained within a post. For example, a user may filter the posts in order to display only photographic posts, audio posts, video posts, multi-media posts, textual posts, or any other type of content contained within a post.

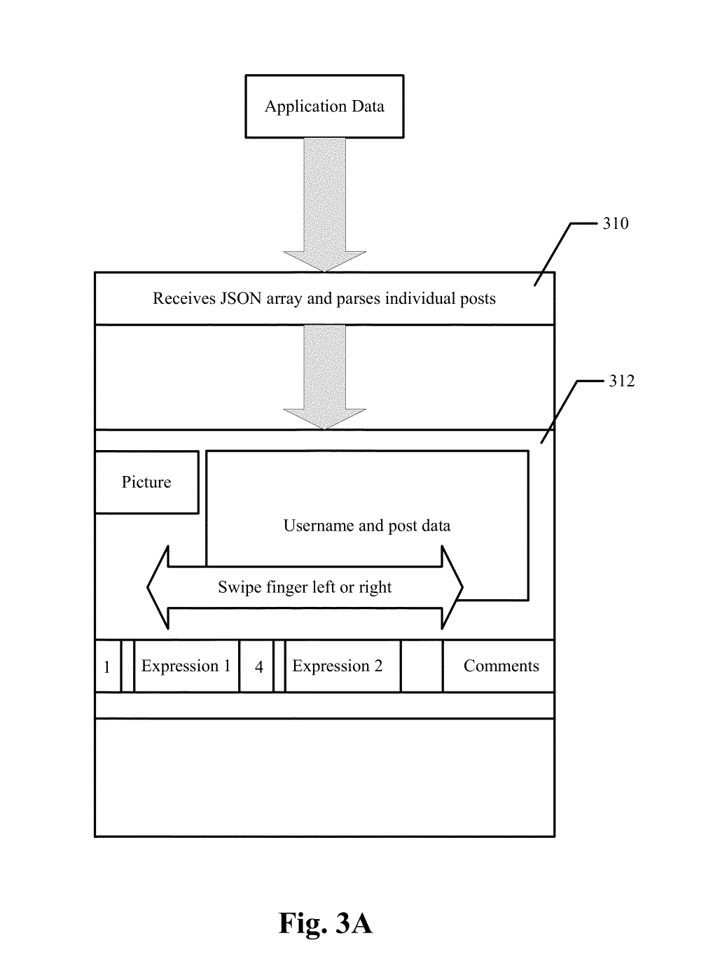

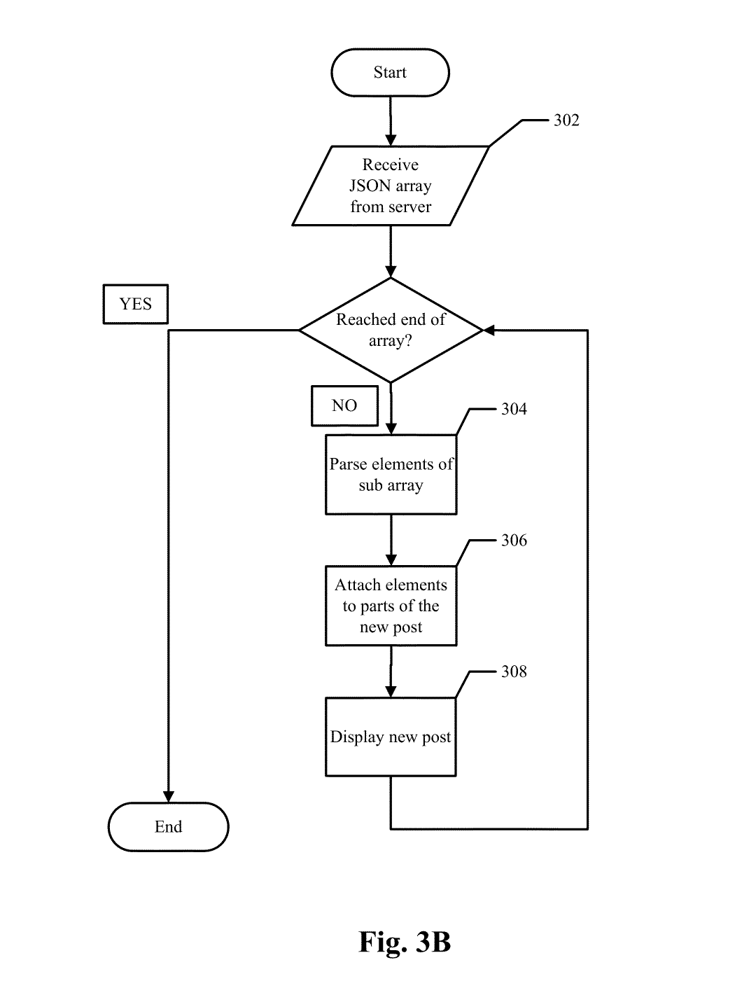

Referring to FIG. 3A, when a user decides to view a feed, account page, or “friends” list, the user, whether he knows it or not, is downloading data from the server. Once the JSON array, which was created earlier in the PHP script, is received by the client, it is then easily parsed by looping through the array and taking out each piece of data needed as noted by its identifier in the array (as illustrated as number 310 of FIG. 3A). These pieces of data are then put together into a viewable post 312, which will then be displayed on the screen along with all of the other posts received from the JSON array. If the post is being viewed in one of the feeds and not a personal account, the elements of the post, as well as the post itself, will be tagged with a “post ID” as well as a “placement ID” for reasons that will be discussed later.

Referring to FIG. 3B, a receiving step 302 provides for the user receiving a JSON array from the server. Once the receiving step 302 is completed, it is determined whether the end of the array is reached. If the end of the array is not reached, a parsing step 304 takes place where elements of a sub array are parsed. The parsing step 304 is followed by an attaching step 306, which includes attaching elements of the sub array to parts of a new post. This attaching step 306 may be followed by a displaying step 308, which includes displaying the new post.

In addition to the custom expressions buttons, when displaying posts in a feed, if the post is tagged in the database as private, as set by the user when they originally created the content, the post will be displayed as described above, however the background color should be different, and a label underneath should alert the user that the post is private and what user created it. These added visual effects allow the user to realize that what they are looking at is not meant for the public eye.

Furthermore, if a user is viewing a location based post within the feed, they will notice that at the end of the text portion of the post, they will find a text button with the persons location. This location will either be the supplied Places API location or the custom location that the poster inputted. When a user taps on this button, a map of that location will be displayed based on the coordinates of the posters location which were uploaded to the server upon submitting the post.

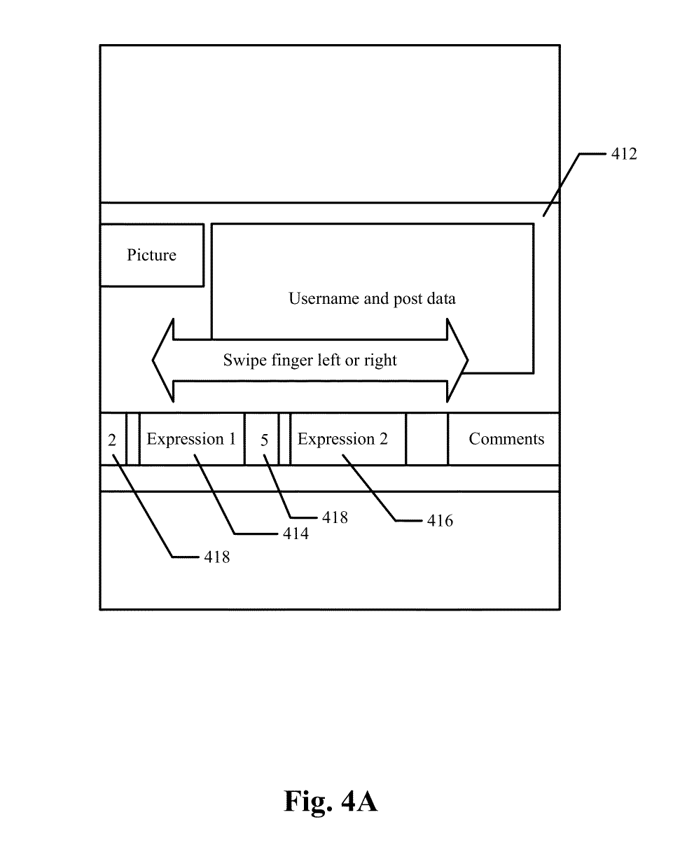

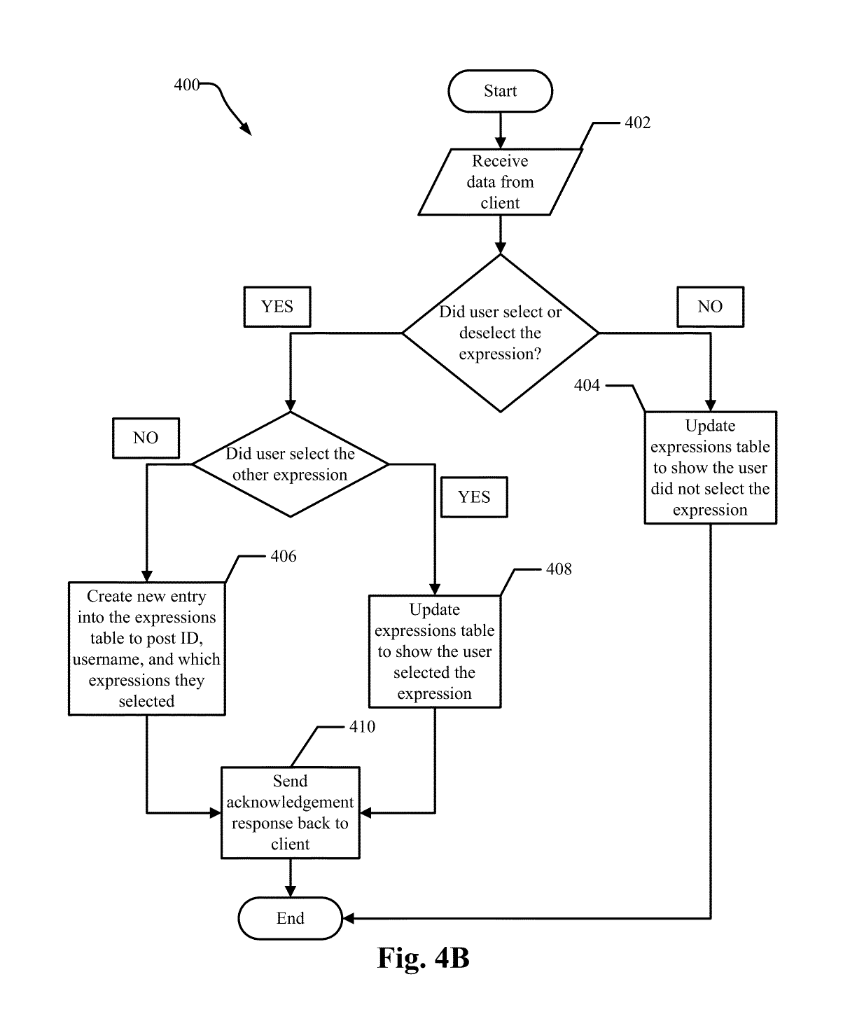

Referring to FIG. 4A, when displaying a post, certain buttons and elements must be created. For example, the username of the poster must be made in plain text with the ability to click on it in order to get to the poster's account page. Additionally, when displaying the post 412, the two custom expression buttons 414 and 416 must be created. The text of these buttons 414 and 416 must display the exact same text that the original post used when creating the post 412, unless of course the user did not input any text, in which case the default values would be used. Furthermore, the buttons 414 and 416 must be tagged with the post ID. The post ID is an integer that is maintained by the database. Every time a new post is inserted into the database, the post ID automatically increments by one and is attached to that post. When the current user selects that expression, his username along with the post ID are sent to the server where the database checks the expressions table to see if the user pressed the other expression for that post. If the user did select the other expression, then the table updates that row by stating that the user now selected both. Otherwise, the table creates a new entry. Once the database is updated, the server will then send a response back to the server, which will tell the application to change the color of that expression and increment the counter 418 directly to the left of the button. It is also possible that the user will change his mind and decide to “deselect” the expression that he originally selected. If this occurs, then the client application will again send the current user's credentials along with the post ID for that button and send it to the server so that the database can update the row for that user on that post. On response from the server, the client will then change the color of the expression back to its original state and decrement the counter 418 directly to the left by one.

Referring now to FIG. 4B, a process 400 demonstrating a method of displaying a post is described. A receiving step 402 entails receiving data from the client. Upon completion of the receiving step 402, it is determined whether the user selected or deselected an expression. If the user did not select or deselect the expression, an updating step 404 is performed where the expressions table is updated to show the user did not select the expression. However, if the user did select or deselect the expression, it is determined whether the user selected the other expression. If the user did not select the other expression, a creating step 406 transpires where a new entry is created into the expressions table with a post ID, username, and which expressions the user selected. If, to the contrary, the user did select the other expression, a updating step 408 performs the function of updating the expressions table to show the user selected the expression. Regardless of whether the creating step 406 or the updating step 408 occurs, a sending step 410 may occur where an acknowledgment response is sent back to the client.

Another element that is visible when viewing a post is the comments button. This button allows the user to comment on a specific post. When parsing the application data for a post, the number of comments on a post as well as the post ID and the original poster's username are attached to this button. The number of comments is then placed on top of the comments icon. Once a user has pressed the button, the application will send to the server the poster and current users' usernames and check the relations table within the database to see if the current user is following the poster. When the client receives the response from the server, if the user is following, then the user will be able to post a comment without any problems. However, if the user is not following, the text input as well as the post button should be disabled so that the user cannot comment on the post. Once the ability for a user to comment on a post has been established, the client will send a “GET” request to the server with the post ID to receive all of the comments for that post. Just like a feed, the client will receive a JSON array, which will then be parsed and formed into viewable comments.

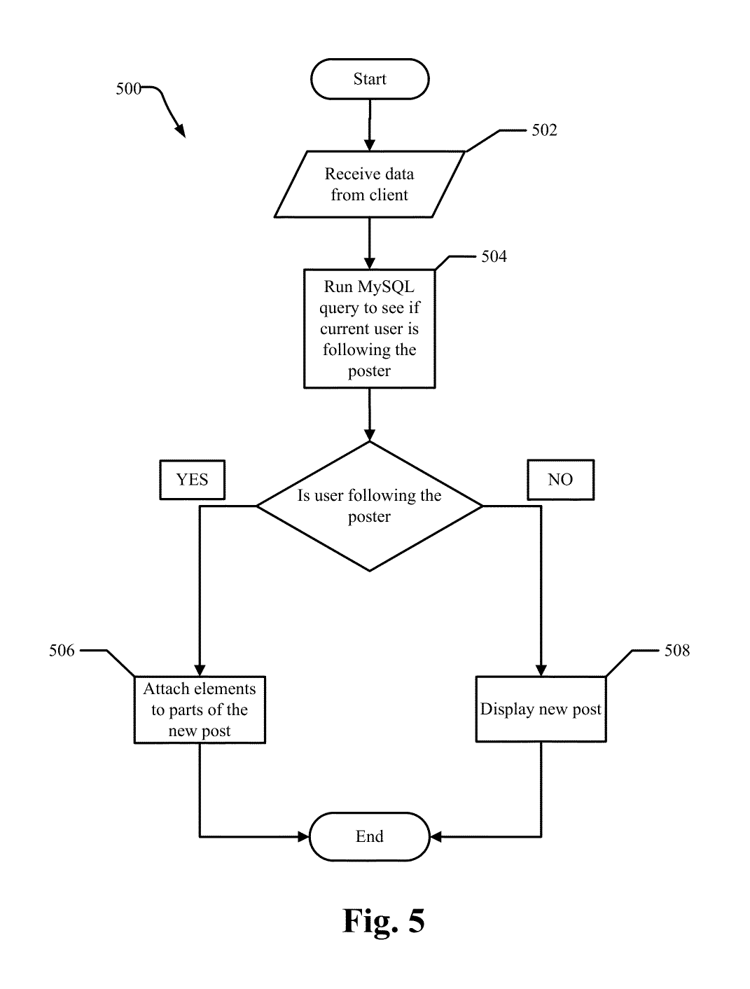

Referring to FIG. 5, a process 500 regarding the management of the comments button is described. A receiving step 502 entails receiving data from the client and a running step 504 involves running a MySQL query to see if the current user is following the poster. If the current user is following the poster, an attaching step 506 transpires that involves attaching elements to parts of the new post. If the current user is not following the poster, a displaying step 508 occurs where the new post is displayed.

When a user is ready to submit his comment, the data that he typed in along with his username and the post ID will be uploaded to the server using a “POST” request. When the server receives the comment, the data is inserted into the comments table of the database along with the comment number for that post.

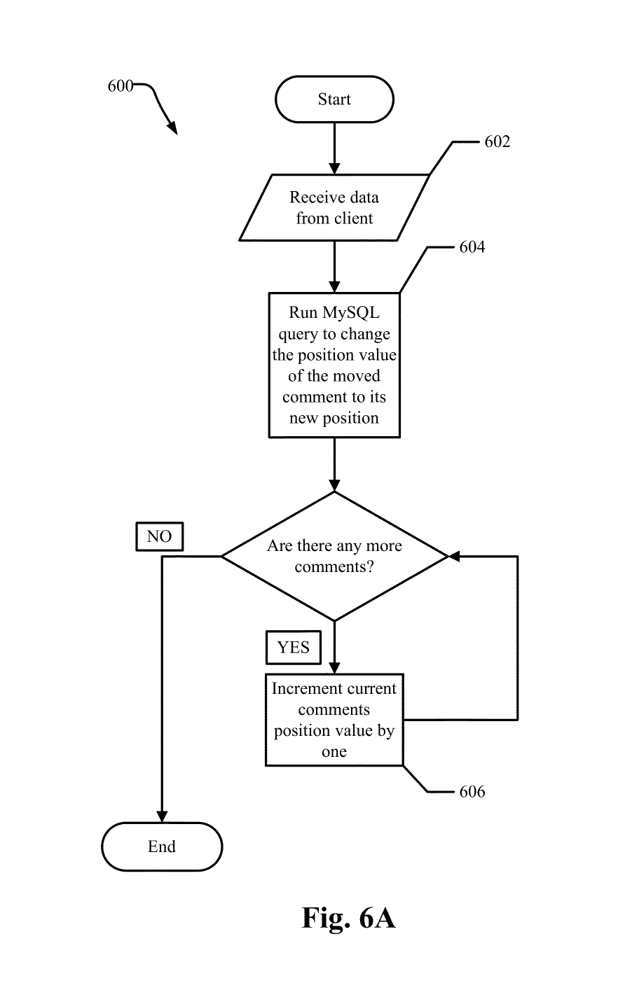

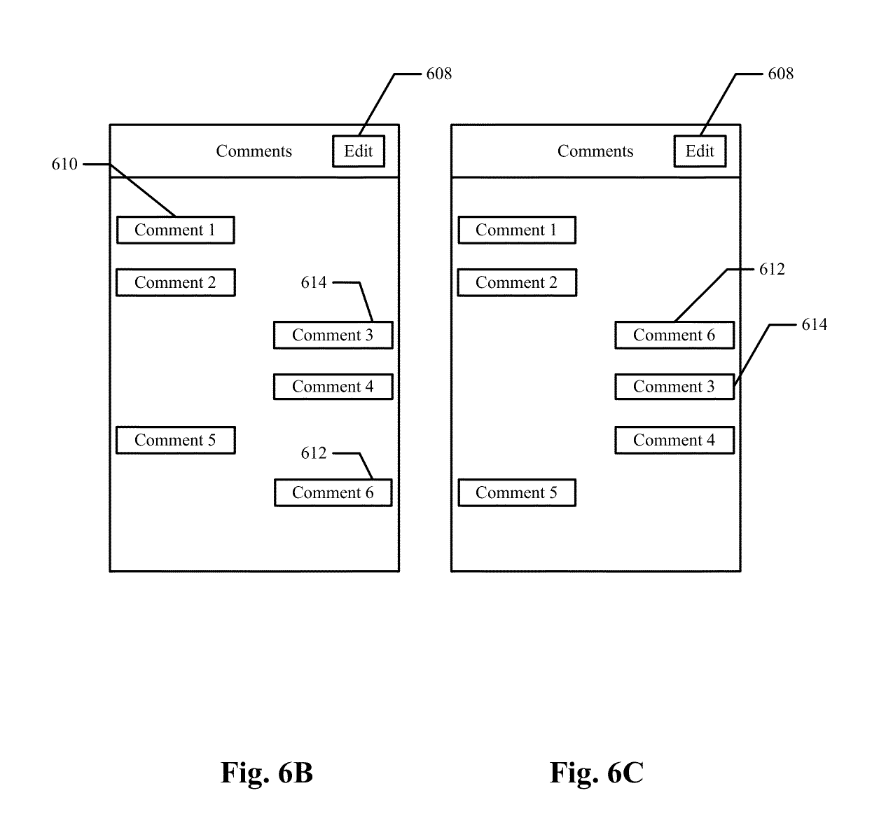

Referring to FIG. 6A, a process 600 regarding the management and movements of comments is described. A receiving step 602 involves receiving data from the client and a running step 604 involves running a MySQL query on the data to change the position value of the moved comment to its new position. If there are more comments, an incrementing step 606 is performed that involves incrementing the current comments position value by one.

A further feature of the comments area is the ability for the original poster to move around his own comments so that he can directly respond to certain comments. Referring to FIG. 6B, an implementation of this feature is described. An edit button 608 may be placed in the top right of the window. When a user presses this button, it will wrap each of his comments in a drag and drop wrapper 610, which also includes the ability for the user to delete the content. In other words, the table that the users content is in becomes editable in terms of being able to change the order as well as deleting content. The user will then have the ability to freely change the order of his comments, or to delete a comment/content, as illustrated in FIGS. 6B and 6C. Once the user has pressed the edit button 608 again signifying that they are done, the client will check to see if any comments were moved. If any comments were moved, the application will send a request to the server to update the placements of the comments in the comments database using a “GET” request. For example, if the user has 6 comments on a post, and he moves the 6th comment 612 before the 3rd comment 614, the server will change the placement value of the 6th comment 612 to the 3rd and increment all of the remaining comments placements by one. On the server side, if a comment was deleted, the server will go ahead and delete the comment from the database and decrement the comments counter for that particular post. Conversely, if the order of comments were changed, then the database will add a temporary time to that comment putting in the time of the comment directly before it that was not moved. If there are multiple comments that were moved then the database will loop through the comments and update their placements such that when the user goes back to the comments area for that post it prints them out in the correct order.

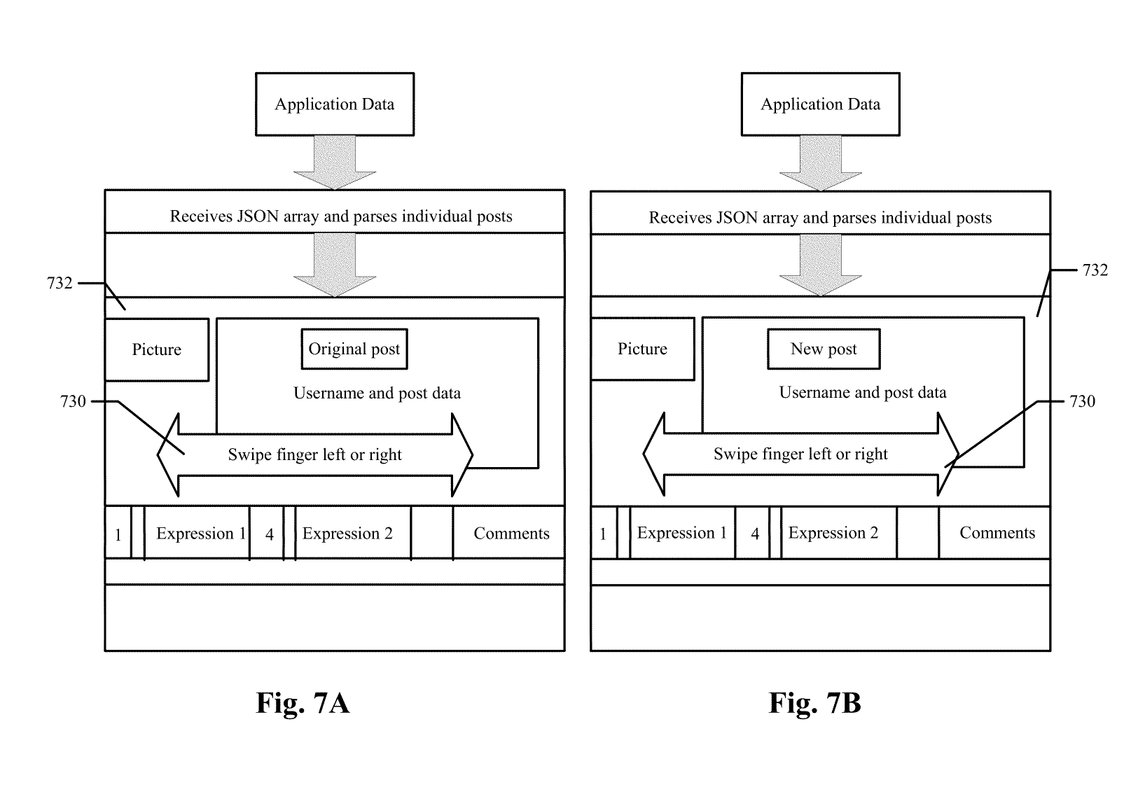

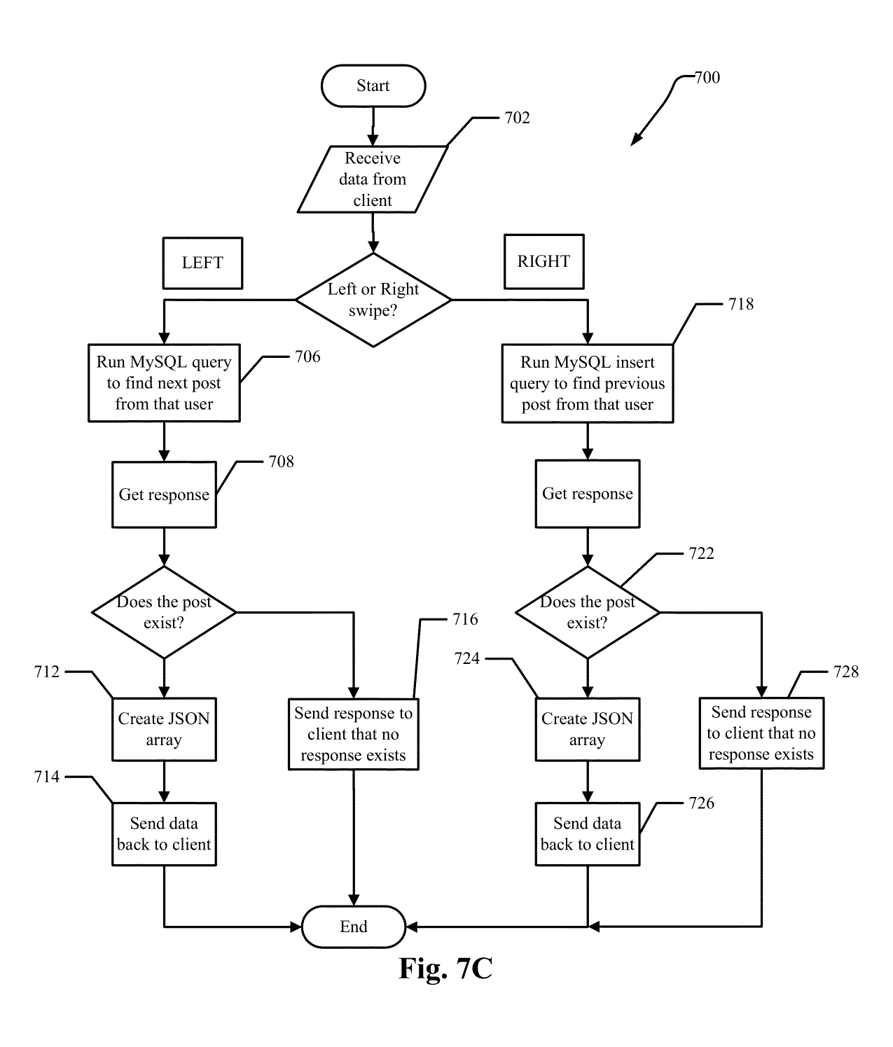

A still further feature, as illustrated in FIGS. 7A and 7B, of the client application is the ability to swipe left or right (as illustrated by number 730 of FIGS. 7A and 7B) on a post 732 to go to the next or previous post created by that individual user. When swiping left or right, the next or previous post of the individual may be displayed in the same location as the originally viewed post of the individual. These posts include any public posts that the user has submitted along with any private posts that the current user may have been tagged in. This is where the placement ID comes into play. We will define the following swipe gestures as such: a swipe up or down is used to scroll through content, a rightward swipe on a post is used to view the previous post from that user and a leftward swipe gesture on a post is used to view the next post from that user. If a left or right gesture is recognized by the client, the application will take note of the post ID as well as the placement ID. The post ID is then sent to the server where the PHP script will run a query to obtain the user who created that post. Once the poster is known, the server will then search for the next or previous post by that user depending on the direction of the swipe. Just like any other post, when the data is found, it is wrapped in a JSON array and sent back to the client, which will then parse it into an object and tag it with the new post ID and the original placement ID. Once the object is finished, the client will then replace the currently viewed post and fade in the new post.

Referring to FIG. 7C, a process 700 for a user to move within a specific user's posts and move around within that user's posts is described. A receiving step 702 involves receiving data from the client. Upon completion of the receiving step 702, it is determined whether the user swiped left or right. If the user swiped left, a running step 706 occurs involving the running of a MySQL query to find the next post from that user. Upon completion of the running step 706, a getting step 708 involves getting the response of the query, and upon completion of the getting step 708, it is determined whether a next post exists. If a next post exists, a creating step 712 is performed where a JSON array is created and a sending step 714 occurs involving data being sent back to the client. If a next post does not exist, a sending step 716 is performed where a response is sent to the client indicating no response exists.

If the user swiped right, a running step 718 occurs where a MySQL query is run to find a previous post from that user. Upon completion of the running step 718, a getting step 720 involves getting the response of the query, and upon completion of the getting step 720, it is determined whether a previous post exists. If a previous post exists, a creating step 724 is performed where a JSON array is created and a sending step 726 occurs involving data being send back to the client. If a previous post does not exist, a sending step 728 is performed where a response is sent to the client indicating no response exists.

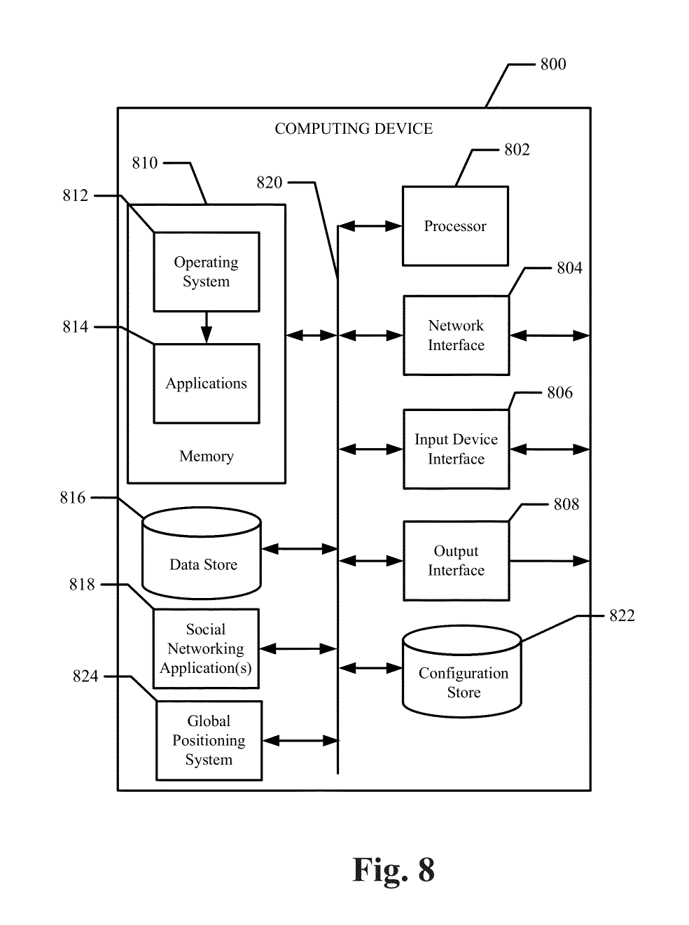

Aspects of the present disclosure may be implemented as a computer implemented method in a computing device or computer system. These computing devices may include, but are not limited to, mobile phones, laptop computers, tablet computers, personal computers, workstations, mini- and mainframe computers, servers, and the like. These computing devices may also include specially configured computers for processing digital multi-media content. The general architecture of a suitable computing device is described below with reference to FIG. 8. More particularly, FIG. 8 is a block diagram illustrating exemplary components of a computing device 800 suitable for processing and streaming media content. However, the following description of the exemplary components of a computing device 800 should be viewed as illustrative only and not construed as limiting in any manner. In one aspect, the device 104 shown in FIG. 1 may be implemented as the exemplary computing device 800, for example.

With regard to FIG. 8, the exemplary computing device 800 may include a processor 802 in communication with a variety of other components over a system bus 820 or through a direct connection. These other components may include, by way of example, a network interface 804, an input device interface 806, an output interface 808, and a memory 810. As appreciated by those skilled in the art, the network interface 804 enables the computing device 800 to communicate data, control messages, data requests, and other information with other resources including computers, data sources, storage devices, and the like, on a computer network such as the Internet. The network interface 804 may be configured to communicate via wired or wireless connections. As one skilled in the art will appreciate, the computing device 800 may obtain content, such as streamed audio, video, and/or game from another computer, a storage device, or other source via the computer network. The computing device 800 may also save the content to a networked location or send it to another computer or satellite on the network, for example.

The input device interface 806, sometimes also embodied as an input/output interface, enables the computing device 800 to obtain data input from a variety of devices including, but not limited to, a microphone, a digital pen, a touch screen, a keyboard, a mouse, a scanner, and the like. In addition to the exemplary components described above, an output interface 808 may be used for outputting information such as audio signals or display information. Audio signals may be output to other user devices, for example. Display information may be output by the output interface 808 via a display device (e.g., a monitor or similar device, not shown), for example. Audio output may also be output by the output interface 808 through an audio device such as a speaker, for example. An audio input device, such as a microphone, may also input audio to the computing device 800. Of course, while not shown, one skilled in the art will appreciate that one or more speakers and/or audio input devices, may be incorporated as integral elements within a computing device 800 or may be separate therefrom.

The processor 802 may be configured to operate in accordance with programming instructions stored in a memory 810. The memory 810 generally comprises RAM, ROM, and/or other memory. Thus, in addition to storage in read/write memory (RAM), programming instructions may also be embodied in read-only format, such as those found in ROM or other permanent memory. The memory 810 may store an operating system 812 for controlling the operation of the computing device 800. The operating system may be a general purpose operating system such as a Microsoft Windows operating system, a UNIX operating system, a Linux operating system, or an operating system specifically written for and tailored to the computing device 800. Similarly, the memory 810 may also store user-executable applications 814, or programs, for conducting various functions on the computing device 800. For example, the application 814 in memory 810 may be configured according to aspects of the present disclosure to control access to content within a geo-fence.

The computing device 800 optionally includes a data store 816, a social networking application(s) 818, a global positioning system 824, and/or a configuration store 822, depending on how the computing device 800 is to be used. For example, if the computing device 800 is a device 104 shown in FIG. 1 it may include the data store 816, the social networking application(s) 818, the global positioning system 824, and the configuration store 822. If the computing device 800 is configured to provide an audio transmission, it may include the configuration store 822. The data store 816 may store location data associated with network availability and signal strength information and may be used to determine the proximity or presence of a user device in relation to the computing device 800 according to aspects of the present disclosure. The social networking application(s) 818 may be configured to perform functions as disclosed and described above with relation to FIGS. 1-7C.

The global positioning system 824 may be configured to allow a device 104, as referenced in FIG. 1 herein, to detect and display a global position location of the device 104. It should also be understood that the description herein is presented largely in terms of logic and operations that may be performed by conventional computer components and media components. These computer components, may be grouped in a single location or distributed over a wide area. In circumstances where the computer components are distributed, the components may be accessible to each other via wired and/or wireless communication links, for example.

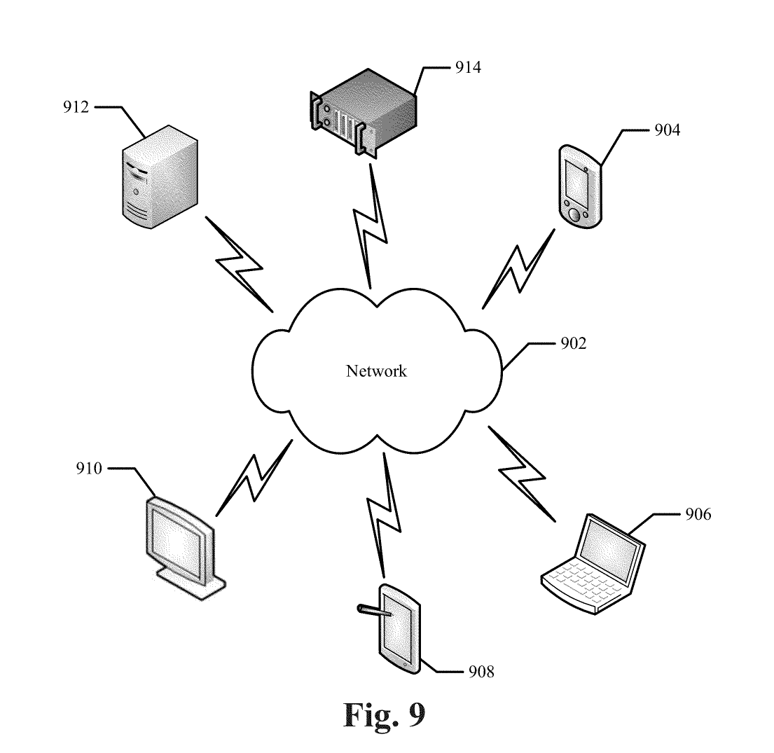

As shown in FIG. 9, multiple devices may be connected over a network 902. Network 902 may include a local or private network or may include a wide network such as the Internet. Devices may be connected to the network 902 through either wired or wireless connections. For example, a wireless device 904 may be connected to the network 902 through a wireless service provider. Other devices, such as laptop 906 or tablet computer 908 may be capable of connection to the network 902 using various connection methods including through a wireless service provider, over a WiFi connection, or the like. Other devices, such as television 910, may connect to the network 902 through a wired or wireless connection.

In certain system configurations, one or more remote devices may perform social networking functions as disclosed and described with reference to FIGS. 1-7C above. For example, content may be sent over the network 902 to television 910 by wireless device 904. The content may be streamed or transmitted in another fashion.

The various embodiments may be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and protocols. Such a system also may include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of communication, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java, C, C# or C++, or any scripting language, such as Perl, Python, or TCL, as well as combinations thereof. The server(s) may also include database servers, including without limitation those commercially available from Oracle, Microsoft, Sybase, and IBM.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad, or microphone), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the system or device. Based on the disclosure and teachings provided herein, a person of ordinary skill in the art will appreciate other ways and/or methods to implement the various embodiments.

While the systems, methods, and apparatuses have been described and illustrated in connection with preferred embodiments, many variations and modifications will be evident to those skilled in the art and may be made without departing from the spirit and scope of the disclosure. The disclosure is thus not to be limited to the precise details of methodology or construction set forth herein, as such variations and modification are intended to be included within the scope of the disclosure.

What is claimed is:

1. A computer system for implementing a social network, comprising,
a processor;
a memory device including instructions operable to be executed by the processor to perform a set of actions, configuring the processor:
to provide a user interface to allow a user to browse content or add content on the computer system;
to allow a user to post custom expressions that will appear in a post as custom expression buttons; and
to post default values for expression buttons when no custom expressions are entered by the user.

2. The computer system of claim 1 wherein the processor is further configured to create a comments button that allows a user to comment on a specific post.

3. The computer system of claim 2 wherein the processor is further configured to allow a user to move around the user's comments or delete or change content of the user's comment.

4. The computer system of claim 1 wherein the custom expression button is associated with a private post that is accessible only to a limited set of users.

5. The computer system of claim 1 wherein the custom expression button is configured in a different background color than other buttons to indicate it is a custom button.

6. The computer system of claim 1 wherein the custom expression button includes a label to alert users that a post is private.

7. The computer system of claim 1 wherein the custom expression button is associated with a private post that includes a label to alert users that the post is private and what user created the post.

8. The computer system of claim 1 wherein the post is configured as a location-based post including user location information provided by one of user supplied location information or user location information from a GPS associated with a user communicating with the computer system.

9. The computer system of claim 8 wherein the location-based post includes a location button provided through the user interface for accessing the user location information.

10. The computer system of claim 9 configured such that when another user interacts with the location button a map of the user location information is provided to the another user.

11. The computer system of claim 2, further wherein the comments button is configured using a table in which comments are stored to and the table can be accessed to allow the user to edit comments stored in the table.

12. The computer system of claim 1 wherein the processor is further configured to allow a user to submit a private post protected to allow viewing by a limited group of individuals.

13. The computer system of claim 12 wherein the private post is protected using a passcode.

14. The computer system of claim 1 wherein the user interface allows the user to browse content according to a content type.

15. The computer system of claim 14 wherein the content type is selected from the group consisting of photographic, video, multimedia, audio, and textual.

16. A computer system for implementing a social network, comprising,
a processor;
a memory device including instructions operable to be executed by the processor to perform a set of actions, configuring the processor:
to provide a touch screen user interface to allow a user to browse content or add content on the computer system;
to allow a user to post custom expressions that will appear in a post as custom expression buttons; and
to allow a user to manage comments affiliated with the post.

17. The computer system of claim 16 wherein a user manages the comments by deleting or changing content of the comments.

18. The computer system of claim 16 wherein a user manages the comments by moving the comments to appear in a different order.

19. The computer system of claim 16 wherein the processor is further configured to allow a user to view different posts created by a single user by swiping the touch screen user interface.

20. The computer system of claim 19 wherein the different posts are displayed in a single location.

21. A method of providing custom expression buttons via a computer interface comprising the steps of:
displaying custom expression buttons;
tagging the custom expression buttons with a post ID;
acknowledging a selection of one of the custom expression buttons;
changing a color of the selected custom expression button; and
incrementing a counter corresponding to the selected custom expression button.

22. The method of claim 21 further comprising the step of:
managing comments upon a user indicating performance of an action selected from the group consisting of deleting comments, changing content of the comments, and moving the comments to appear in a different order.

23. The method of claim 21 further comprising the step of:
displaying a next or a previous post upon a user swiping a touch screen user interface.

24. The method of claim 23 wherein the displaying step includes the next or the previous post being created by a single user.
